(19) United States
(12) Patent Application Publication
(10) Pub. No.: US 2006/0279827 A1
(43) Pub. Date: Dec. 14, 2006

(54) Wide angle beam director

(75) Inventors: Richard A. Hutchin, Calabasas, CA (US); Oberdan W. Otto, Camarillo, CA (US)

Correspondence Address: CONNOLLY BOVE LODGE & HUTZ LLP, P.O. BOX 2207, WILMINGTON, DE, 19899, US

(73) Assignee: OPTICAL PHYSICS COMPANY

(21) Appl. No.: 11/150,743

(22) Filed: Jun. 10, 2005

(51) Int. Cl. G02B 26/08

(52) U.S. Cl. 359/211; 359/209

(57) ABSTRACT

A beam directing apparatus comprises a beam translator and a beam director. The beam translator is adapted to receive a beam at an input aperture and to output the beam at an output aperture, with the beam at the output aperture being parallel to the beam at the input aperture. The beam translator is further adapted to be capable of spatially translating the beam at the output aperture relative to the optical axis of the beam at the input aperture. The beam director includes at least one beam directing stage having a rotatable prism which is optically coupled to the output aperture.

### BACKGROUND OF THE INVENTION

1. Field of the Invention

The field of the present invention is pointing and directing apparatuses and methods for light, particularly those apparatuses and methods which provide wide angle fields of view for directing beams of light.

2. Background

Risley prisms, i.e., a pair of generally identical prisms, have long been utilized to point beams of light. An advantageous configuration for pointing beams of light using Risley prisms is achieved when the two prisms are identical. The ideal configuration involves propagating a beam of light through the two prisms such that the angle, θ, between the incident beam and the normal to each prism bisector remains constant as the prisms rotate. The angle of incidence is then chosen so that the refracted light propagates through each prism along the normal to the prism bisector. Under these conditions, the exit angle of the beam emerging from each prism is the same as the angle of incidence, and the resulting angle between the incident beam and the exiting beam for each prism is a constant 2θ. The combination of the two prisms enables a maximum angular offset between the incident beam and the exiting beam of 4θ.

Independent rotation of the prisms allows the beam exiting the Risley prism to be pointed at any direction within a cone having its apex at the Risley prisms and having an apex angle of 4θ. The apex angle of the cone, and thus the breadth of direction available to point the beam, may be broadened to 6θ by the addition of a third prism. A third prism also provides an additional degree of rotational freedom, thereby improving the speed at which the desired output direction of the beam may be obtained. Such beam directors, however, are not without their shortcomings.

A first shortcoming is that three-beam directing stages necessarily create lateral displacement of the light beam as the beam is swept from a zero angle direction to the maximum angle of 6θ. This lateral displacement necessitates a larger exit aperture for the beam director. For applications such as airborne operations, where space is at a premium, the larger exit aperture increases the surface area needed for operation of such a beam director and reduces the space available for other equipment.

A second shortcoming is that the entire assembly of a multi-beam directing stage can be sensitive to vibratory or other motion caused by the vehicle to which it is mounted. This sensitivity can cause unwanted rotation of one or more of the stages, thereby creating alignment problems for the entire beam director assembly.

### SUMMARY OF THE INVENTION

The present invention is directed toward a beam directing apparatus which comprises a beam director including at least one beam directing stage. A rotatable prism is included in the at least one beam directing stage. Rotation of the prism enables a light beam passing through the prism to be pointed in a desired direction.

In a first separate aspect of the present invention, a beam translator includes an input aperture and an output aperture. The output aperture is optically coupled to the prism of the beam director. The beam translator receives a beam at the input aperture and outputs the beam at the output aperture such that the beam at the output aperture is parallel to the beam at the input aperture. Further, the beam translator is adapted to be capable of spatially translating the beam at the output aperture, the translation being relative to the optical axis of the beam at the input aperture. The translation may be accomplished using either reflective optics or refractive optics. For additional functionality, the beam translator may be rotatably coupled to the beam director and may also be movable between at least a first configuration in which the beam is not spatially translated and a second configuration in which the beam is spatially translated.

In a second separate aspect of the present invention, the beam director comprises at least two beam directing stages which are rotatably coupled together. Each beam directing stage includes a prism, and each is adapted to rotate about an axis. The first beam directing stage rotates about a first axis. A first counterbalance is affixed to the first beam directing stage such that the first beam directing stage and the first counterbalance, in combination, have a center of mass on the first axis. The second beam directing stage rotates about a second axis. A second counterbalance is affixed to the second beam directing stage such that the second beam directing stage, the second counterbalance, the first beam directing stage, and the first counterbalance, in combination, have a center of mass on the second axis. The first and second axes may be angularly offset from each other.

In a third separate aspect of the present invention, any of the foregoing aspects may be employed in combination.

Accordingly, the present invention provides an improved beam directing apparatus. Other objects and advantages will appear hereinafter.

### BRIEF DESCRIPTION OF THE DRAWINGS

In the drawings, wherein like reference numerals refer to similar components:

FIG. 1 schematically illustrates an embodiment of a beam directing apparatus;

FIG. 2A is a perspective view of a prism employed in the beam directing apparatus;

FIG. 2B schematically illustrates the preferred angle of incidence for a beam on a prism, the prism being part of a beam director;

FIGS. 3A & 3B schematically illustrate two possible configurations for a beam director having three beam directing stages;

FIGS. 4A & 4B schematically illustrate and compare the exit apertures for a non-translated beam director and a translated beam director;

FIGS. 5A & 5B schematically illustrate a beam translator having refractive optics;

FIGS. 6A & 6B schematically illustrate a beam translator having reflective optics;

FIG. 7 schematically illustrates a counterbalanced beam director having two beam directing stages; and

FIG. 8 schematically illustrates a counterbalanced beam director having three beam directing stages.

### DETAILED DESCRIPTION OF THE PREFERRED EMBODIMENTS

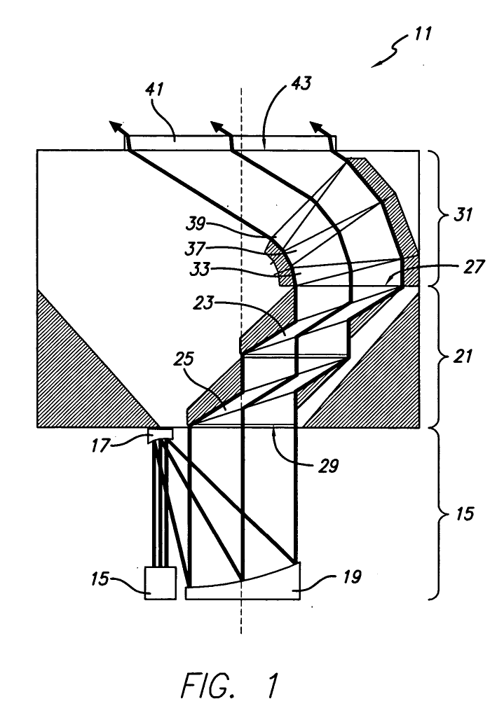

Turning in detail to the drawings, FIG. 1 illustrates the primary components of a beam directing apparatus 11, which may be employed to transmit an outgoing beam or, alternatively, receive an incoming beam. A collimated beam of light from a source 13 is directed into a beam expander 15 having a convex mirror 17 and a concave mirror 19. The convex mirror 17 is employed to expand the beam, and the concave mirror 19 is employed to re-collimate the beam to the desired beam width. The beam expander 15 is optically coupled to and directs the expanded beam into the beam translator 21. The beam translator 21 includes two refractive elements 23, 25 which enable the beam translator 21 to translate the beam at the output aperture 27 of the beam translator 21 relative to the optical axis of the beam at the input aperture 29 of the beam translator 21. The beam translator 21, in turn, is optically coupled to and directs the expanded beam into the beam director 31. The beam director 31 is rotatable relative to the beam translator 21 and includes three independently rotatable prisms 33, 37, 39 which enable the beam director 31 to output the beam at any output angle up to 6θ. The beam emerging from the beam director 31 passes through the refractive element 41 disposed at the output aperture 43 of the beam directing apparatus 11. This refractive element 43 facilitates the beam passing through the hull or skin (not shown) of an airplane or other platform on which the beam directing apparatus 11 is employed.

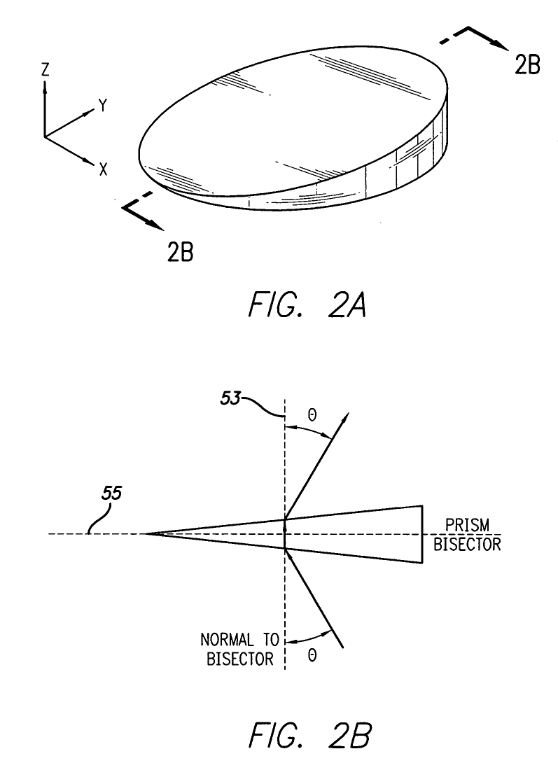

FIG. 2A illustrates the form of each prism employed in the beam director. The prism 51 has an isoscelean cross section in the y-z plane and a circular cross section in the x-y plane. FIG. 2B illustrates the alignment of each prism relative to the beam passing through the beam director. The prism 51 is aligned such that the beam propagating through the prism 51 travels along a normal 53 to the prism bisector 55. The angle between the beam exiting the prism 51 and the beam entering the prism 51 is 2θ, where θ is the angle between the beam entering the prism 51 and the normal to the prism bisector 55. Rotation of the prism about the optical axis of the beam entering the prism 51 results in a constant output angle of the beam exiting the prism 51.

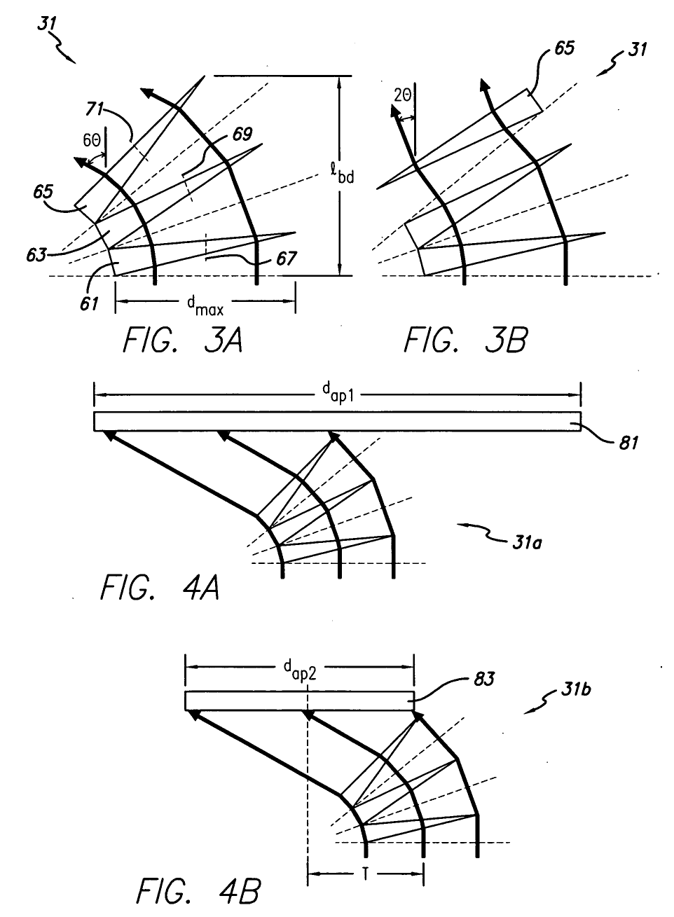

FIG. 3A illustrates one possible relative alignment of three identical prisms 61, 63, 65 in a beam director 31, although the prisms need not be identical. Each prism 61, 63, 65 is aligned, relative to the beam entering each respective prism, as described and shown in FIG. 2, and each is optically coupled to the other prisms, either directly or indirectly. Further, each prism 61, 63, 65 is rotatable about an axis of rotation 67, 69, 71 at the center of each respective prism, the axis of rotation 67, 69, 71 being parallel to the optical axis of the incident beam at the point where the beam enters each respective prism. With a deflection of 20 degrees per prism, the overall length, l_{bd}, of the beam director is preferably approximately 1.3 times the maximum beam diameter, dₘₐₓ, which the beam director 31 is capable of transmitting. Each prism deflects the path of the beam by 2θ, with the combined deflection of all three prisms being 6θ in the configuration shown. This is the maximum deflection of the beam director 31. In comparison, FIG. 3B illustrates the same three prism beam director 31 with the third prism 65 rotated by 180°. In this configuration, the first and second prisms 61, 63 deflect the beam in a first direction by a total of 4θ, while the third prism 65 deflects the beam in the opposite direction by a total of 2θ. The total deflection of the beam passing through the beam director 31 with this configuration is 2θ. Many different configurations of the beam director are possible by rotating one or more of the prisms relative to the other prisms, such that the net deflection of the beam is anywhere between 0° and 6θ.

FIGS. 4A and 4B illustrate a comparison between two beam directors 31a, 31b configured for a maximum deflection of 60 degrees. In FIG. 4A, the beam director (31a) is not translated and thus utilizes an exit aperture 81 having a diameter, dₐₚ₁, of approximately 4.2 times the width of the maximum beam diameter. In comparison, the beam director 31b shown in FIG. 4B is translated by a lateral distance, T, relative to the entrance aperture to the beam directing apparatus (see FIG. 1), which is approximately 1.15 times the maximum beam diameter. This translated beam director 31a utilizes an exit aperture 83 having a diameter, dₐₚ₂, of approximately 2.1 times the maximum beam diameter. The size of this exit aperture 83 is effectively the same as the size of the exit aperture needed for a beam director employing a single stage with one prism.

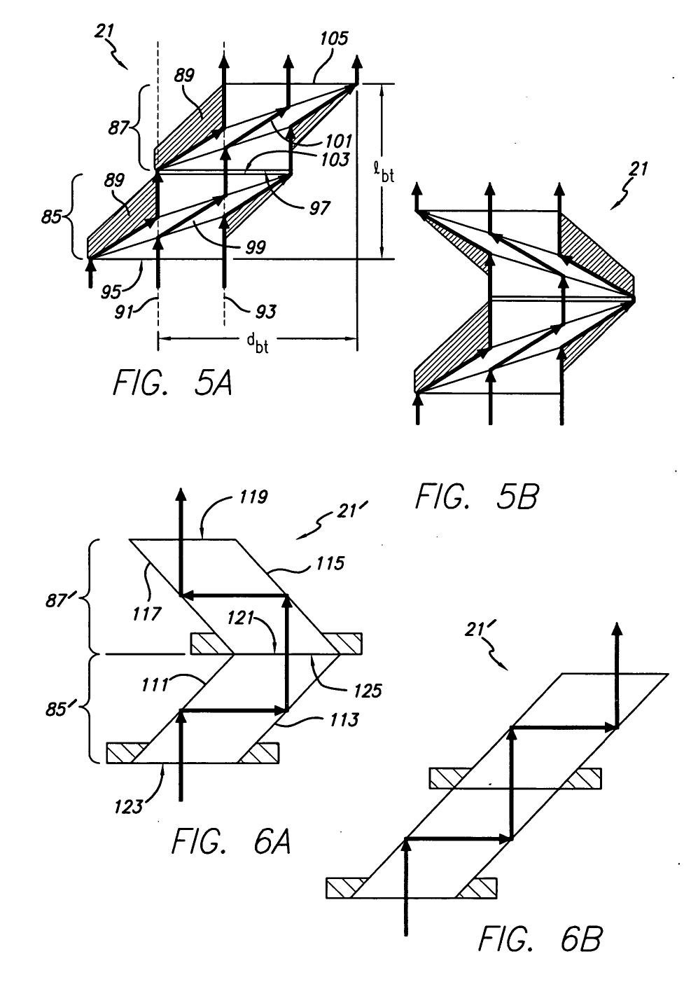

FIGS. 5A and 5B illustrate two configurations of a beam translator 21, 21 employing refractive optics. Referring to FIG. 5A, the beam translator 21 includes two rotatable stages 85, 87. Each stage 85, 87 includes optical elements and associated mechanical structure 89 to support the optical elements and to enable independent rotation of each respective stage. The support structure and mechanical components of the rotatable coupling are entirely a matter of design choice. The beam translator 21 preferably has an overall length, l_{bt}, of approximately 1.35 times the maximum beam diameter. Each stage 85, 87 is rotatable about the optical axis 91, 93 of the beam at the entrance aperture 95, 97 to each respective stage 85, 87. As shown, the optical elements of each stage 85, 87 consist of a single refractive element 99, 101, wherein the combination of the index of refraction, the shape, and the position of each refractive element 99, 101 cause the beam at the output aperture 103, 105 of each respective stage 85, 87 to be parallel to the beam at the input aperture 99, 101 of each respective stage 85, 87. The beam translator 21a shown in FIG. 5A is configured to spatially translate the beam at the output aperture 105 of the second stage 87, relative to the optical axis of the beam at the input aperture 95 to the first stage 85, by approximately 1.15 times the maximum beam diameter. As a result, the overall diameter, d_{bt}, of the beam translator is approximately 3.3 times the maximum beam width. FIG. 5B shows the beam translator 21 configured so that the beam is not spatially translated. The beam translator may have any configuration between the two extremes shown in FIGS. 5A and 5B by rotating the two stages 85, 87 relative to each other.

FIGS. 6A and 6B illustrate two configurations of a beam translator 21′ employing reflective optics. Referring to FIG. 6A, each stage 85, 87 includes reflective surfaces 111, 113, 115, 117 which are aligned to cause the beam at the output aperture 119, 121 of each respective stage 85′, 87′ to be parallel to the beam at the input aperture 123, 125 of each respective stage 85′, 87′. FIG. 6A shows the reflective beam translator 21′ configured so that the beam is not spatially translated. FIG. 6B shows the reflective beam translator 21′ configured to spatially translate the beam at the output aperture of the second stage 121, relative to the optical axis of the beam at the input aperture 123 to the first stage 85.

The overall dimensions of the beam directing apparatus of FIG. 1, exclusive of the beam expander portion, is important when space utilization is critical, such as it is in many airborne platform deployments. This is often particularly true for the size of the exit aperture because it may be required to penetrate through the outer wall or skin of an aircraft. The beam directing apparatus described above increases the overall length dimension while decreasing the overall diameter dimension for what in many instances will be a favorable trade-off between reduced exit aperture area and increased system length. The overall surface area is reduced by approximately 38%, while the surface area of the exit aperture is reduced by approximately 75%. As a trade-off, the overall length of the beam directing apparatus is increased by approximately 100%. For many airborne application, this tradeoff is beneficial because it frees up valuable exterior space on the platform and significantly reduces the size of the exit aperture.

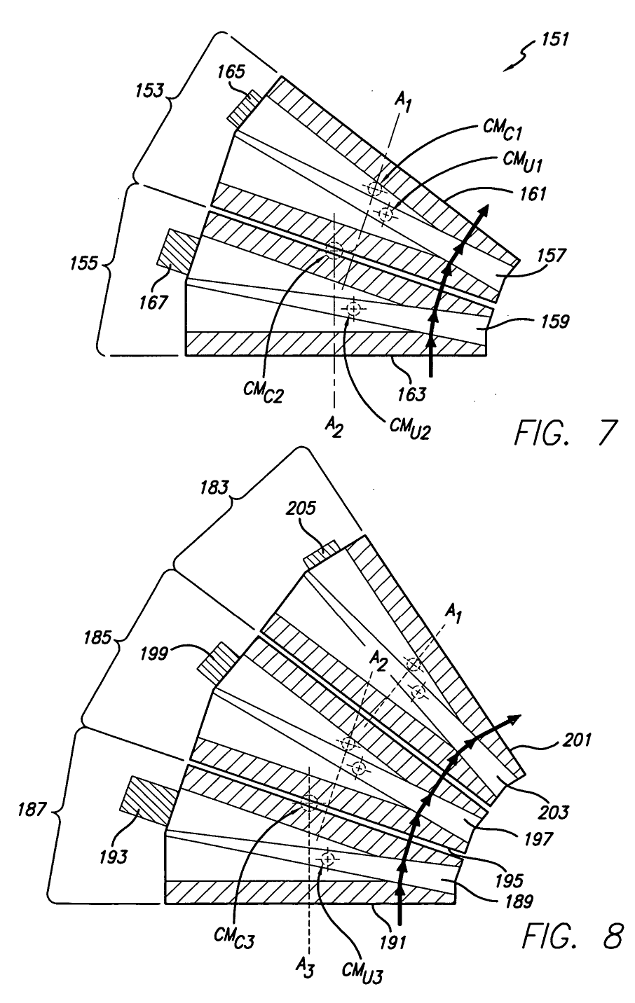

A balanced beam director 151 is illustrated in FIG. 7. This beam director 151 has two stages 153, 155 which are rotatably coupled for independent rotation about their respective axes. As with the beam translator, the mechanical components for the support structure and the rotatable coupling are entirely a matter of design choice. Each stage 153, 155 includes a prism 157, 159, mechanical structure 161, 163 for supporting and rotating each respective prism 157, 159, and a counterbalance 165, 167. The prisms 157, 159 are aligned as described above in connection with FIGS. 2B and 3A. The first stage 153 is rotatable about the first axis, A₁, and the second stage 157 is rotatable about the second axis, A₂. The relative alignment of the prisms renders the first and second axes, A₁ and A₂, not parallel. The counterbalances 165, 167 are affixed to the mechanical structure 161, 163 of each stage 153, 155, respectively, to bring the center of mass of each stage into alignment with the axis of rotation for each respective stage. The center of mass for the second stage 155, however, is not independent of the first stage mass. Therefore, balancing of the second stage 155 is done after the first stage 153 is balanced. Similarly, if additional stages are included in the beam director (see FIG. 8), then each stage is balanced in sequence following the technique described below.

Excluding the first counterbalance 165, the first stage 153, which includes the prism 157 and the mechanical structure 161, has an uncorrected center of mass, CMᵤ₁, lying off the first axis, A₁. The first counterbalance 165 is affixed to the mechanical structure 161 to create a corrected center of mass, CM_{c1}, for the first stage 153 lying on the first axis, A₁.

Excluding the second counterbalance 167, the second stage 155 has an uncorrected center of mass, CMᵤ₂, lying off the second axis, A₂. Because the first and second stages 153, 155 are mechanically coupled, the uncorrected center of mass, CMᵤ₂, for the second stage 155 is determined by the mechanical structure 153 and the prism 159 of the second stage 155 plus the mechanical structure 161, the prism 157, and the first counterbalance 165 of the first stage 153. The second counterbalance 167 is therefore affixed to the mechanical structure 163 of the second stage 155 in order to create a corrected center of mass, CM_{c2}, lying on the second axis, A₂, for the combination of the first stage 153, inclusive of the first counterbalance 165, and the second stage 155.

A three-stage balanced beam director 181, which is constructed in the manner described above, is illustrated in FIG. 8. The first two stages 183, 185 of the beam director 181 are balanced as described in relation to FIG. 7. The third stage 187 of this balanced beam director 181 includes a prism 189, a mechanical structure 191 for supporting and rotating the prism 189, and a counterbalance 193. This third stage 187 is rotatable about the third axis, A₃, and has a corrected center of mass, CM_{c3}, lying on the third axis, A₃. The third stage 187 is directly mechanically coupled to the second stage 185 and indirectly mechanically coupled to the first stage 183. Therefore, without the third counterbalance 193, the uncorrected center of mass, CMᵤ₂, for the third stage 187 is determined by the combination of the mechanical structure 191 and prism 189 of the third stage 187, the mechanical structure 195, the prism 197, and the second counterbalance 199 of the second stage 185, plus the mechanical structure 201, the prism 203, and the first counterbalance 205 of the first stage 183. Adding the third counterbalance 193 to this combination creates a corrected center of mass, CM_{c3}, onto the third axis, A₃.

The above method of iterative counterbalancing helps eliminate unwanted rotations of the various stages of the beam director. When the center of mass of any single stage, taking into account the mechanical coupling between the stages, does not lie on the axis of rotation for that stage, platform accelerations (such as airplane vibrations) will induce rotation of the stage because such platform accelerations act on the center of mass to create a torque about the axis of rotation. With the center of mass lying on the axis of rotation, balanced forces do not cause unwanted rotation because no torque is created. Thus, only a force that is unbalanced, i.e. produces a torque, will cause rotation of a stage. A torque drive mechanism (not shown), preferably a DC motor with a frictional contact between its shaft and its encoder disk, is employed in association with each stage of the beam director to enable each respective stage.

Thus, an improved beam directing apparatus is disclosed. While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A beam directing apparatus comprising:
a beam translator adapted to receive a beam at an input aperture and output the beam at an output aperture, the beam at the output aperture being parallel to the beam at the input aperture, wherein the beam translator is adapted to be capable of spatially translating the beam at the output aperture relative to an optical axis of the beam at the input aperture; and
a beam director including at least one beam directing stage having a rotatable prism, the prism being optically coupled to the output aperture.

2. The apparatus of claim 1, wherein the beam translator is movable between a first configuration in which the beam is not spatially translated and a second configuration in which the beam is spatially translated.

3. The apparatus of claim 1, wherein the beam translator is rotatable about the optical axis.

4. The apparatus of claim 1, wherein the beam director is rotatably coupled to the output aperture.

5. The apparatus of claim 1, wherein the beam director comprises three beam directing stages, each beam directing stage including a rotatable prism that is optically coupled to the beam translator.

6. The apparatus of claim 5, wherein each prism is rotatable independently of the other prisms.

7. The apparatus of claim 1, wherein the beam translator comprises a plurality of reflective surfaces which translate the beam.

8. The apparatus of claim 1, wherein the beam translator comprises a plurality of refractive elements which translate the beam.

9. A beam directing apparatus comprising:
a beam translator adapted to receive a beam at an input aperture and output the beam at an output aperture, the beam at the output aperture being parallel to the beam at the input aperture, wherein the beam translator is adapted to be capable of spatially translating the beam at the output aperture relative to an optical axis of the beam at the input aperture and is movable between a first configuration in which the beam is not spatially translated and a second configuration in which the beam is spatially translated; and
a beam director rotatably coupled to the output aperture, the beam director including at least one beam directing stage having a rotatable prism, wherein the prism is optically coupled to the output aperture.

10. The apparatus of claim 9, wherein the beam translator is rotatable about the optical axis.

11. The apparatus of claim 9, wherein the beam director comprises three beam directing stages, each beam directing stage including a rotatable prism that is optically coupled to the beam translator.

12. The apparatus of claim 9, wherein each prism is rotatable independently of the other prisms.

13. The apparatus of claim 9, wherein the beam translator comprises a plurality of reflective surfaces which translate the beam.

14. The apparatus of claim 9, wherein the beam translator comprises a plurality of refractive elements which translate the beam.

15. A beam directing apparatus comprising:
a beam translator adapted to receive a beam at an input aperture and output the beam at an output aperture, the beam at the output aperture being parallel to the beam at the input aperture, wherein the beam translator is adapted to rotate about an optical axis of the beam at the input aperture, is adapted to be capable of spatially translating the beam at the output aperture relative to the optical axis, and is movable between a first configuration in which the beam is not spatially translated and a second configuration in which the beam is spatially translated; and
a beam director rotatably coupled to the output aperture, the beam director including at least three beam directing stages, each beam directing stage including a rotatable prism optically coupled to the output aperture.

16. The apparatus of claim 15, wherein each prism is rotatable independently of the other prisms.

17. The apparatus of claim 15, wherein the beam translator comprises a plurality of reflective surfaces which translate the beam.

18. The apparatus of claim 15, wherein the beam translator comprises a plurality of refractive elements which translate the beam.

19. A beam directing apparatus comprising:
a first beam directing stage including a first prism, wherein the first beam directing stage is adapted to rotate about a first axis;
a first counterbalance affixed to the first beam directing stage, wherein the first beam directing stage and the first counterbalance, in combination, have a first center of mass on the first axis; and
a second beam directing stage rotatably coupled to the first beam directing stage, wherein the second beam directing stage includes a second prism and is adapted to rotate about a second axis; and
a second counterbalance affixed to the second beam directing stage, wherein the second beam directing stage, the second counterbalance, the first beam directing stage, and the first counterbalance, in combination, have a second center of mass on the second axis.

20. The apparatus of claim 19, wherein the first prism is optically coupled to the second prism.

21. The apparatus of claim 19, wherein the first axis is angularly offset from the second axis.

22. A beam directing apparatus comprising:
a first beam directing stage including a first prism, wherein the first beam directing stage is adapted to rotate about a first axis;
a first counterbalance affixed to the first beam directing stage, wherein the first beam directing stage and the first counterbalance, in combination, have a first center of mass on the first axis; and
a second beam directing stage rotatably coupled to the first beam directing stage, wherein the second beam directing stage includes a second prism and is adapted to rotate about a second axis, the second prism being optically coupled to the first prism;
a second counterbalance affixed to the second beam directing stage, wherein the second beam directing stage, the second counterbalance, the first beam directing stage, and the first counterbalance, in combination, have a second center of mass on the second axis;
a third beam directing stage rotatably coupled to the second beam directing stage, wherein the third beam directing stage includes a third prism and is adapted to rotate about a third axis, the third prism being optically coupled to the second prism; and
a third counterbalance affixed to the third beam directing stage, wherein the third beam directing stage, the third counterbalance, the second beam directing stage, the second counterbalance, the first beam directing stage, and the first counterbalance, in combination, have a third center of mass on the third axis.

23. The apparatus of claim 22, wherein the second axis is angularly offset from the first axis.

24. The apparatus of claim 22, wherein the third axis is angularly offset from the first and second axes.

25. A beam directing apparatus comprising:
a beam translator adapted to receive a beam at an input aperture and output the beam at an output aperture, the beam at the output aperture being parallel to the beam at the input aperture, wherein the beam translator is adapted to rotate about an optical axis of the beam at the input aperture, is adapted to be capable of spatially translating the beam at the output aperture relative to the optical axis, and includes a first configuration in which the beam is not spatially translated and a second configuration in which the beam is spatially translated;
a first beam directing stage including a first prism, wherein the first beam directing stage is adapted to rotate about a first axis, the first prism being optically coupled to the output aperture;
a first counterbalance affixed to the first beam directing stage, wherein the first beam directing stage and the first counterbalance, in combination, have a first center of mass on the first axis; and
a second beam directing stage rotatably coupled to the first beam directing stage, wherein the second beam directing stage includes a second prism and is adapted to rotate about a second axis which is angularly offset from the first axis, the second prism being optically coupled to the first prism and to the output aperture;
a second counterbalance affixed to the second beam directing stage, wherein the second beam directing stage, the second counterbalance, the first beam directing stage, and the first counterbalance, in combination, have a second center of mass on the second axis;
a third beam directing stage rotatably coupled to the second beam directing stage and to the output aperture, wherein the third beam directing stage includes a third prism and is adapted to rotate about an optical axis of the beam at the output aperture, the optical axis being angularly offset from the first and second axes and the third prism being optically coupled to the second prism and to the output aperture; and
a third counterbalance affixed to the third beam directing stage, wherein the third beam directing stage, the third counterbalance, the second beam directing stage, the second counterbalance, the first beam directing stage, and the first counterbalance, in combination, have a third center of mass on the optical axis.

26. A method of counterbalancing a beam directing apparatus, the method comprising:
affixing a first counterbalance to a first beam directing stage of the beam directing apparatus, the first beam directing stage being rotatable about a first axis, wherein the first counterbalance and the first beam directing stage, in combination, have a first center of mass on the first axis; and
affixing a second counterbalance to a second beam directing stage of the beam directing apparatus, the second beam directing stage being rotatably affixed to the first beam directing stage and being rotatable about a second axis which is angularly offset from the first axis, wherein the second counterbalance, the second beam directing stage, the first counterbalance, and the first beam directing stage, in combination, have a second center of mass on the second axis.

27. The method of claim 26 further comprising affixing a third counterbalance to a third beam directing stage of the beam directing apparatus, the third beam directing stage being rotatably affixed to the second beam directing stage and being rotatable about a third axis which is angularly offset from the first and second axes, wherein the third counterbalance, the third beam directing stage, the second counterbalance, the second beam directing stage, the first counterbalance, and the first beam directing stage, in combination, have a third center of mass on the third axis.
